(19) United States
(12) Patent Application Publication
(10) Pub. No.: US 2022/0304873 A1
(43) Pub. Date: Sep. 29, 2022

(54) SHOWER SEAT

(71) Applicant: Xiamen Aquasu Electric Shower Co., Ltd., Xiamen (CN)

(72) Inventors: Quanduo Hou, Xiamen (CN); Yan Zeng, Xiamen (CN)

(21) Appl. No.: 17/234,822

(22) Filed: Apr. 20, 2021

(30) Foreign Application Priority Data
Mar. 25, 2021 (CN) 202120613404.3

(51) Int. Cl. A61G 5/14

(52) U.S. Cl. CPC A61G 5/14

(57) ABSTRACT

Disclosed is a shower seat. The shower seat comprises a support assembly, an elevator assembly, a seat assembly, and a control assembly. The support assembly is capable of being located on a wall. The elevator assembly comprises a push rod motor, a movable seat and a guide shaft; the movable is connected to an output end of the push rod motor. The movable seat is capable of moving along the guide shaft. The seat assembly comprises a seat plate hinged to the movable seat, and hinge rods respectively hinged to the seat plate and the support assembly. The hinge rod is hinged to the support assembly at a first position lower than a second position where the hinge rod and the seat plate are hinged. The push rod motor is connected to the control assembly. The control assembly is capable of controlling an movement of the push rod motor.

### CROSS REFERENCE OF RELATED APPLICATIONS

The present application claims the benefit of China Patent Application No. 202120613404.3, entitled “Shower Seat”, filed on Mar. 25, 2021, in the China National Intellectual Property Administration, the entire content of which is incorporated herein in its entirety.

### TECHNICAL FIELD

The subject matter herein relates to a technical filed of seat equipment, in particular to shower seat.

### BACKGROUND

Shower seats are equipment arranged in the bathroom for facilitating people to take a shower in sitting state. In recent years, it has become more and more popular among people, and is especially convenient for the elderly to take a comfortable shower.

At present, most shower seats are directly fixed to the wall, and the structure and function of these seats are relatively simple. In addition, there is also some sower seats that can be stored in the prior art, but such shower seats either realized by a simple hinge manner which is not only weak in structural strength but also unable to assist the users in standing, or too complicated for switching between different states.

### SUMMARY

The object of the present disclosure is to provide a shower seat to solve the disadvantages of the prior art.

The shower seat comprises:
a support assembly, the support assembly being capable of being located on the wall;
an elevator assembly, comprising a push rod motor, a movable seat and a guide shaft; the movable is connected to an output end of the push rod motor; the movable seat is capable of moving along the guide shaft;
a seat assembly, the seat assembly comprising a seat plate hinged to the movable seat, and hinge rods respectively hinged to the seat plate and the support assembly; the hinge rod is hinged to the support assembly at a first position lower than a second position where the hinge rod and the seat plate are hinged;
a control assembly;
the push rod motor is electrically connected to the control assembly; the control assembly is capable of controlling an expansion/contraction amount of the push rod motor; the push rod motor is capable of driving the movable seat upward to force the seat plate to rotate downward to be in a substantially vertical state; the push rod moto is capable of driving the movable seat to move downward to force the seat plate to rotate upward to be in a substantially horizonal state.

In some embodiments, the elevator assembly further comprises a connecting plate and a hinge seat; the connecting plate is vertically arranged on the movable seat; the hinge seat is arranged to the connected to the connecting plate; the output end of the push rod motor is hinged to the hinge seat.

In some embodiments, the elevator assembly further comprises a pair of guide shafts and a pair of guide blocks; each guide shaft in the pair of guide shafts is vertically arranged on the support assembly, and located at both sides of the push rod motor; each guide block of the pair of guide blocks is respectively arranged on the movable seat, and is movably attached to the guide shaft.

In some embodiments, the support assembly comprises a first support, a second support and a third support; the guide shaft is connected to the first support, the second support and the third support respectively from the top down.

In some embodiments, the push rod motor is arranged on the third support.

In some embodiments, the support assembly further comprises a decoration case for covering the support assembly; the movable seat is capable of freely moving up and down relative to the decoration case.

In some embodiments, the movable seat is a circular geometric body that is sheathed on the decoration case.

In some embodiments, the seat assembly further comprises a back plate substantially vertically arranged on the connecting plate.

In some embodiments, the seat assembly further comprises a seat cushion arranged on the seat plate.

In some embodiments, the hinge rod is a rod-shaped member with a U-shaped cross section, and two side walls of the hinge rod is hinged to the seat plate and the support assembly in a manner that two side walls of the hinge rod are hinged to the seat plate and the support assembly.

In view of the above disclosure, following technical effect may be obtained.

1. In the shower seat of the present disclosure, the seat assembly can be efficiently switched between the stowed state and the seated state through the push rod motor. In addition, in the shower seat of this application, since the seat plate can always bear the supporting force from the connecting seat and the hinge rod during the process of changing the seated state to the stowed state, it can assist the elderly from the sitting posture to a standing posture.

2. The shower seat of the present disclosure can ensure the stable up and down movement of the movable seat through the cooperation of a pair of guide shafts and a pair of guide blocks.

### BRIEF DESCRIPTION OF THE DRAWINGS

In order to explain the technical features of the embodiments of the present invention more clearly, the following will briefly introduce the drawings that need to be used in the embodiments. It should be understood that the following drawings only show certain embodiments of the present invention, and therefore it should not be regarded as a limitation of the scope. For those of ordinary skill in the art, other related drawings can be obtained from these drawings without creative work.

FIG. 1 is a first schematic diagram of the shower seat according to one embodiment of the present disclosure.

FIG. 2 is a first partially exploded view of the shower seat according to one embodiment of the present disclosure.

FIG. 3 is a second schematic diagram of the shower seat according to one embodiment of the present disclosure.

FIG. 4 is a second partially exploded view of the shower seat (without the decoration cas) according to one embodiment of the present disclosure.

FIG. 5 is a third schematic diagram of the shower seat according to one embodiment of the present disclosure.

FIG. 6 is a schematic diagram of the shower seat in a first state according to one embodiment of the present disclosure.

FIG. 7 is a schematic diagram of the shower seat in a second state according to one embodiment of the present disclosure.

In the drawings:
100-seat assembly; 110-seat plate; 120-hinge rod; 130-back plate; 140-seat cushion;
200-support assembly; 210-first support; 220-second support; 230-third support; 240-decoration case;
300-elevator assembly; 310-push rod motor; 320-movable seat; 330-guide block; 340-connecting plate; 350-hinge seat; 360-guide shaft;
400-control assembly.

### DETAILED DESCRIPTION OF THE INVENTION

In order to make the objectives, technical solutions and advantages of the embodiments of the present invention clearer, the technical solutions in the embodiments of the present invention will be described clearly and completely in conjunction with the accompanying drawings in the embodiments of the present invention. Obviously, the described embodiments It is a part of the embodiments of the present invention, not all the embodiments. Based on the embodiments of the present invention, all other embodiments obtained by those of ordinary skill in the art without creative work fall within the protection scope of the present invention. Therefore, the following detailed description of the embodiments of the present invention provided in the accompanying drawings is not intended to limit the scope of the claimed invention, but merely represents selected embodiments of the present invention. Based on the embodiments of the present invention, all other embodiments obtained by those of ordinary skill in the art without creative work fall within the protection scope of the present invention.

The present disclosure will be further described in detail below with reference to the drawings and specific embodiments.

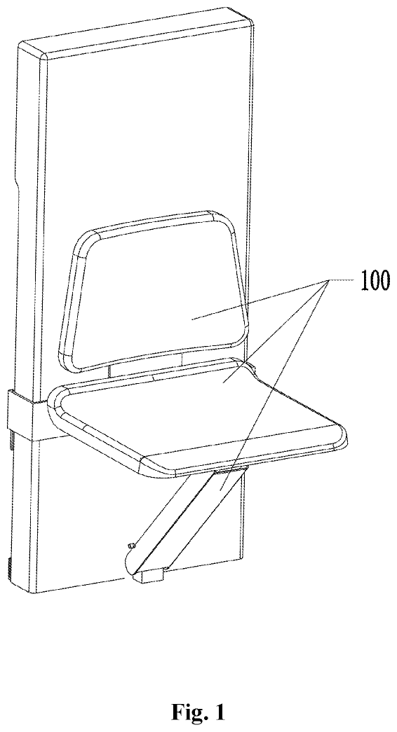

Referring to FIGS. 1-4, the present disclosure provides a shower seat. The shower seat comprises a seat assembly 100, a support assembly 200, an elevator assembly 300 and a control assembly. The support assembly 100 is capable of being located on a wall. The elevator assembly 200 and the seat assembly 100 are respectively arranged on the support assembly 200. The elevator assembly 300 is configured to drive the seat assembly 100 to be in different state. The control assembly 400 is configured to control the work state of the elevator assembly 300 and therefore allowing the seat assembly 100 to accurately maintained in different state.

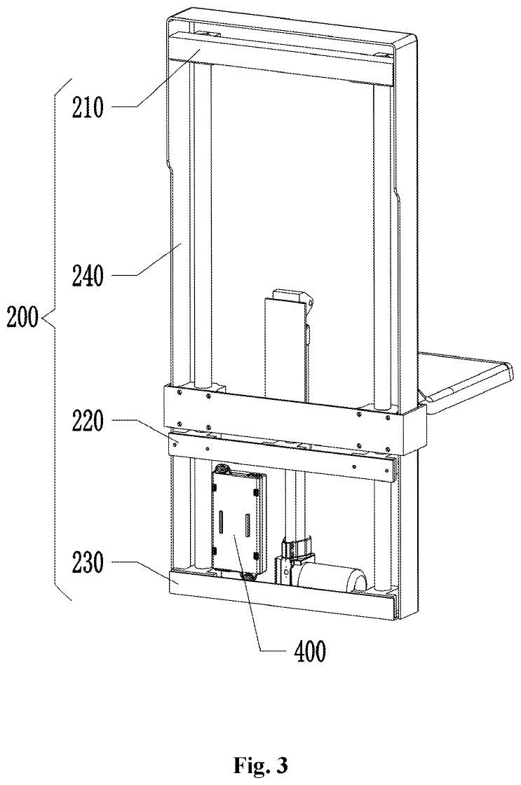

More specifically, as shown in FIG. 3, in this embodiment, the support assembly 200 comprises a first support 210, a second support 220 and a third support 230. The first support 210, the second support 220 and the third support 230 all are arranged transversely.

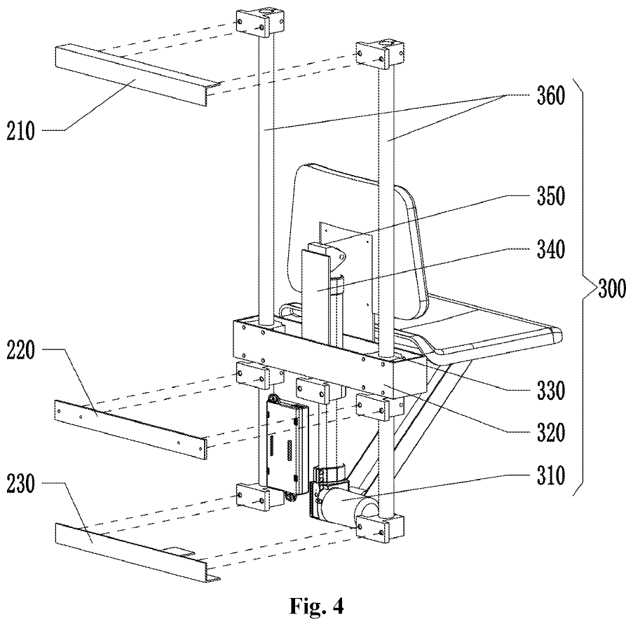

As shown in FIG. 4, in this embodiment, the elevator assembly 300 comprises a push rod motor 310, a movable seat 320, a connecting plate 340, a hinge seat 350, a pair of guide shaft 360 and a pair of guide blocks 330. The push rod motor 310 is arranged on the third support 230. The output end of the push rod motor 310 is vertically arranged. In order to make the push rod motor 310 attached to the seat assembly 200 more firmly, the output end of the push rod motor 310 is anchored to the second support 220 through a clamp. Each of the guide shaft 360 is vertically arranged on the support assembly 200 and the pair of guide shafts 360 are respectively located at both sides of the push rod motor 310. More specifically, the first support 210, the second support 220 and the third support 230 are located at the same side of the guide shaft 360. The guide shaft 360 is connected to the first support 210, the second support 220 and the third support 230 respectively from the top down. The pair of guide blocks 330 are respectively fitted over the pair of guide shafts 360. Each of the guide blocks 330 is arranged on the movable seat 320. The connecting plate 340 is vertically arranged on the movable seat 320. The connecting plate 340 comprises an extension portion which is extended upwards. The hinge seat 350 is arranged on the extension portion of the connecting plate 340. The output end of the push rod motor 310 is hinged to the hinge seat 350. During work, the push rod motor 310 is capable of driving the connecting plate 340, the movable seat 320 and the guide blocks 330 to move up and down relative to the guide shafts 360. In this disclosure, the shower seat can ensure the stable up and down movement of the movable seat through the cooperation of a pair of guide shafts and a pair of guide blocks.

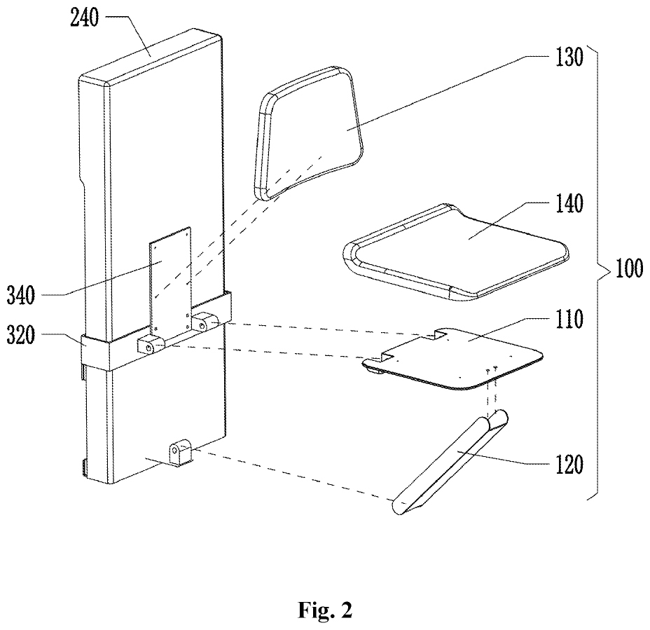

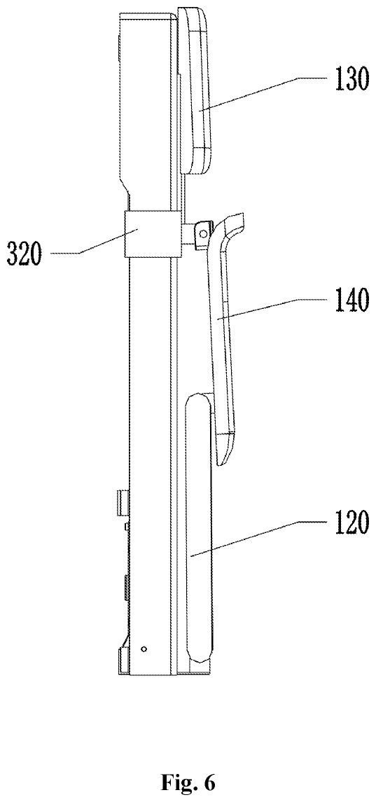

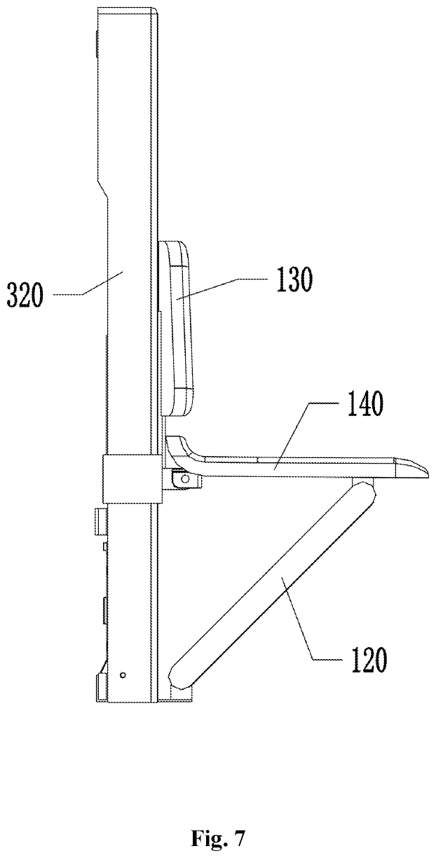

As shown in FIG. 2, FIG. 6 and FIG. 7, in the embodiment, the seat assembly 100 comprises a seat plate 110 and a hinge rod 120. A rear end of the seat plate 110 is hinged to the movable seat 320. Two ends of the hinge rod 120 are respectively hinged to the seat plate 110 and the support assembly 200. The hinge rod 120 is hinged to the support assembly 100 at a first position lower than a second position where the hinge rod 120 and the seat plate 110 are hinged.

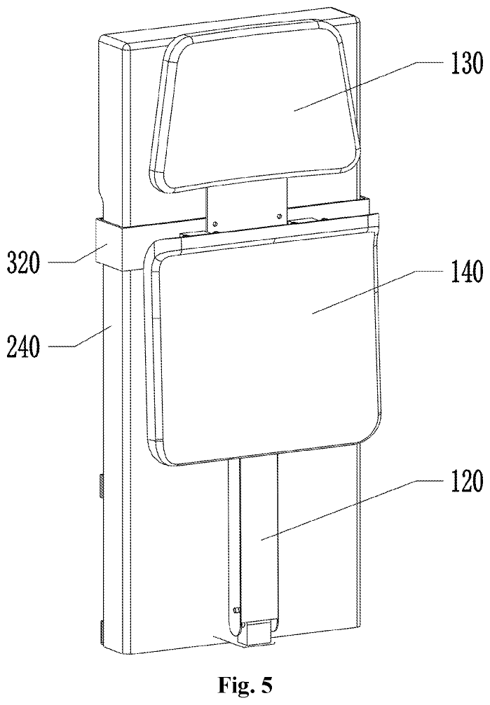

During work, the push rod motor 310 will drive the movable seat 320 to move upwards along the guide shaft 360, and force the seat plate 110 to rotate downwards about its fixed rear end, and the push rod motor 310 will not stop working until the seat plate 100 is in a vertical state. At this moment, the seat assembly 100 is in a stowed state. The push rod motor 310 is also capable of driving the movable seat 320 to move downwards and force the seat plate 110 to rotate upwards about its fixed rear end. With the downwards movement of movable seat 320, the seat plate 110 is rotated upwards until the seat plate 110 is in a horizontal state. And the push rod motor 310 stops working when the seat plate 110 is in a substantially horizontal state. At this moment, the seat assembly 100 is in a service state (seated state). More specifically, as shown in FIG. 1 and FIG. 7, the seat assembly 100 is in the service state. As shown in FIG. 5 and FIG. 6, the seat assembly 100 is in the stowed state.

To be noted, in the movement as described above, the work state of the push rod motor 310 is controlled by the control assembly 400. The control mechanism 400 is preset with information such as the working state and working time of the push rod motor 310, so that the amount of expansion and contraction of the push rod motor 310 is enough to make the seat assembly 100 in the stowed state and the seated state. The control assembly 400 controls the expansion and contraction amount of the push rod motor 310, which belongs to the prior art, and will not be repeated here. In addition, since the expansion and contraction movement of the push rod motor 310 is a more efficient movement than reciprocating movement of a screw mechanism, it allows the seat to be switched from the stored state to the seated state more quickly, so that users may have a better experience. Of course, from the service state to the stowed state, the expansion and contraction speed of the push rod motor 310 can be preset according to the actual requirements of the user, and will not be repeated here.

When the seat assembly 100 is switched from a seated state to a stored state, it can assist a person seated on the seat assembly 100 from a sitting posture to a standing posture, which can play a role in assisting standing. At the same time, the seat assembly 100 may be in the stowed state and occupy less for the bathroom.

As shown in FIG. 2 and FIG. 3, in the embodiment, the support assembly 200 further comprises a decoration case 240 configured for covering the support assembly 200. The movable seat 320 is a circular geometric body that is sheathed on the decoration case 240. The movable seat 320 can move up and down relative to the decoration case 240 freely. The decoration case 240 can cover the first support 210, the second support 220 and the third support 230.

As shown in FIG. 2, in this embodiment, the seat assembly 100 further comprises a back plate 130 arranged substantially vertically on the movable seat 320 and a seat cushion 140 arranged on the seat plate 110. The back plate 130 can serve as a backrest for the user, and the seat cushion 140 is arranged on the upper surface of the seat plate 110. The seat cushion 140 may be made of a skin-friendly material, and the shape of the seat cushion 140 may be adapted for sitting. When the push rod motor 310 drives the seat assembly 100 to change between the two states, the back plate 130 will move up and down along with the movable seat 320, and the seat cushion 140 will be rotated along with the seat plate.

In addition, as shown in FIGS. 2 and 4, in this embodiment, the hinge rod 120 is a rod-shaped member with a U-shaped cross section. The seat plate 110 and the support assembly 200 are both provided with protrusions for forming hinges. The protrusion is located in the U-shaped groove of the rod-shaped member, and the protrusion and the two side walls of the U-shaped groove form a hinge. The rod-shaped member with the above structure may not only enhance its structural strength, but also can make the articulation mode between the hinge rod 120 and the seat plate 110 and the support assembly 200 more stable.

Through the above-mentioned solution of this embodiment, through the push rod motor 310, the shower seat in this disclosure may efficiently realize the switching between the service state and the stowed state. Both the hinge rod 120 and the push rod motor 310 may provide sufficient support force to achieve the function of assisting standing, but also ensure the long-term reliable work of the shower seat.

The above descriptions are only the preferred embodiments of the present disclosure and are not intended to limit the present disclosure. For those skilled in the art, the present disclosure may have various modifications and changes. Any modification, equivalent replacement, improvement, etc. made within the spirit and principle of the present disclosure shall be deemed as falling in the protection scope of this disclosure.

What is claimed is:

1. A shower seat, comprising:
a support assembly, the support assembly being capable of being located on a wall;
an elevator assembly, comprising a push rod motor, a movable seat and a guide shaft; the movable is connected to an output end of the push rod motor; the movable seat is capable of moving along the guide shaft;
a seat assembly, the seat assembly comprising a seat plate hinged to the movable seat, and hinge rods respectively hinged to the seat plate and the support assembly; the hinge rod is hinged to the support assembly at a first position lower than a second position where the hinge rod and the seat plate are hinged;
a control assembly;
the push rod motor is electrically connected to the control assembly; the control assembly is capable of controlling an expansion/contraction amount of the push rod motor; the push rod motor is capable of driving the movable seat upward to force the seat plate to rotate downward to be in a substantially vertical state; the push rod moto is capable of driving the movable seat to move downward to force the seat plate to rotate upward to be in a substantially horizonal state.

2. The shower seat according to claim 1, wherein the elevator assembly further comprises a connecting plate and a hinge seat; the connecting plate is vertically arranged on the movable seat; the hinge seat is arranged to the connected to the connecting plate; the output end of the push rod motor is hinged to the hinge seat.

3. The shower seat according to claim 1, wherein the elevator assembly further comprises a pair of guide shafts and a pair of guide blocks; each guide shaft in the pair of guide shafts is vertically arranged on the support assembly, and located at both sides of the push rod motor; each guide block of the pair of guide blocks is respectively arranged on the movable seat, and is movably attached to the guide shaft.

4. The shower seat according to claim 3, wherein the support assembly comprises a first support, a second support and a third support; the guide shaft is connected to the first support, the second support and the third support respectively from the top down.

5. The shower seat according to claim 4, wherein the push rod motor is arranged on the third support.

6. The shower seat according to claim 1, wherein the support assembly further comprises a decoration case for covering the support assembly; the movable seat is capable of freely moving up and down relative to the decoration case.

7. The shower seat according to claim 6, wherein the movable seat is a circular geometric body that is sheathed on the decoration case.

8. The shower seat according to claim 1, wherein the seat assembly further comprises a back plate substantially vertically arranged on the connecting plate.

9. The shower seat according to claim 1, wherein the seat assembly further comprises a seat cushion arranged on the seat plate.

10. The shower seat according to claim 1, wherein the hinge rod is a rod-shaped member with a U-shaped cross section, and two side walls of the hinge rod is hinged to the seat plate and the support assembly in a manner that two side walls of the hinge rod are hinged to the seat plate and the support assembly.
